(19) United States
(12) Patent Application Publication
(10) Pub. No.: US 2015/0090090 A1
(43) Pub. Date: Apr. 2, 2015

(54) CUTTING OR STAMPING TOOL

(71) Applicant: Weil Engineering GmbH, Mullheim (DE)

(72) Inventor: Anton Jere, Ottenbach (DE)

(73) Assignee: WEIL ENGINEERING GMBH, Mullheim (DE)

(21) Appl. No.: 14/497,830

(22) Filed: Sep. 26, 2014

(30) Foreign Application Priority Data
Sep. 27, 2013 (DE) 202013008594.0

(51) Int. Cl. B26F 1/14; B26D 1/00

(52) U.S. Cl. CPC B26F 1/14; B26D 1/0006; B26D 2001/0046; B26D 2001/006
USPC 83/669; 83/676

(57) ABSTRACT

The invention relates to a cutting or punching tool (9) which is formed from several material layers (14, 15) and carries a tool blade or a tool sleeve, wherein the tool blade or the tool sleeve tapers in a direction of the cutting edge (12) in the region of a bevel (13). It is characteristic of the cutting or punching tool (9) according to the invention for the cutting or punching tool (9) to be produced from at least two material layers (14, 15) that are connected together and are produced from material of varying hardness, that the edge is formed from at least one blade-thin cutting edge layer (14; 14a, 14b, 14c), that the at least one cutting edge layer (14; 14a, 14b, 14c) is connected at least on one of its two flat or peripheral sides to at least one carrier layer (15), which at least one carrier layer (15) carries the bevel (13) that tapers in the direction of the cutting edge (12) and that the at least one carrier layer (15) has a hardness that is less than that of the at least one cutting edge layer (14; 14a, 14b, 14c). The cutting or punching tool (9) according to the invention is characterized in that its cutting edge (12) comprises a high level of cutting sharpness over a longer period of use (cf. FIG. 12).

### BACKGROUND

The invention relates to a cutting or punching tool which is formed from several material layers and has a tool blade or a tool sleeve which carries an edge with a cutting edge, wherein the tool blade or the tool sleeve tapers in the region of a bevel in the direction of the cutting edge.

Cutting or punching tools are already previously known in the many different realizations for the most varied of applications. Thus, cutting tools which are formed from several material layers and the tool blade of which is realized as a cutter blade or saw blade are already known. Punching tools can, in contrast, comprise a tool blade or a tool sleeve by way of which sections can be punched out of a strip of material.

Thus, punching machines which comprise a multitude of punching sleeves, by way of which punching sleeves substantially round sections are able to be punched out of a strip of clutch lining material, have already been created. A clutch disk carrier, which is provided on the surface with an adhesive layer and on which the sections punched out by the punching sleeves can be pressed out and bonded, can be positioned beneath the punching sleeves and the strip of clutch lining material. As, however, the material used as clutch lining has an abrasive effect, the cutting edges on the punching sleeves quickly become blunt. In the end, this results in not only the punched edges on the side of the punched-out section facing the clutch disk carrier but also the punched edges located on the opposite free end face of the clutch lining section becoming frayed. This fraying of the punched edges, however, then makes it more difficult, for example, for the oil used in an automatic transmission to flow through, which in the end results in the combustion engine having a three to five percent higher fuel consumption.

### SUMMARY

Consequently, the object, in particular, is to create a cutting or punching tool of the type mentioned in the introduction where the cutting edge does not become blunt even over a longer period of use.

The solution according to the invention to meeting this object in the case of the cutting or punching tool of the type mentioned in the introduction is provided, in particular, in that the cutting or punching tool is produced from at least two material layers which are connected together on the flat or peripheral sides and are produced from material of varying hardness, that the edge is formed from at least one blade-thin cutting edge layer, that the at least one cutting edge layer is connected at least on one of its two flat or peripheral sides to at least one carrier layer, which at least one carrier layer carries the bevel that tapers in the direction of the cutting edge, and that the at least one carrier layer comprises a hardness that is less than that of the at least one cutting edge layer.

The tool according to the invention can be developed as a cutter or circular cutter, splitting band, saw blade or similar cutting tool. The tool according to the invention, however, can also be realized as a punching tool. The cutting or punching tool according to the invention is realized with multiple layers and comprises a tool blade or a tool sleeve which carries an edge with a cutting edge. The tool blade and the tool sleeve taper in the region of a bevel in the direction of the cutting edge. In this case, the cutting or punching tool according to the invention is produced from at least two material layers which are connected together on the flat sides or the peripheral sides of the sleeve and are produced from material of varying hardness. The edge is formed from a least one preferably blade-thin layer and correspondingly sharp cutting-edge which is connected to at least one carrier layer on at least one of its two flat sides. This carrier layer, which supports the blade-thin cutting edge layer in a dimensionally stable manner, carries the bevel that tapers in the direction of the cutting edge and comprises a hardness which is less than that of the at least one cutting edge. Whereas the comparatively soft carrier layer can consequently wear on abrasive material in such a manner that the bevel remains unchanged, the at least one cutting edge layer, which is preferably blade-thin and forms a sharp cutting edge, is in contrast hard and resistant in such a manner that the cutting or punching tool according to the invention does not become blunt even over a longer period of time.

In order to promote the sharpness of the cutting edge even more over an even longer period of time, it is advantageous when a hardness of the at least one cutting edge layer is greater than that of the product being cut or ground.

So that the carrier layer, in contrast, is able to wear in such a manner that the bevel always remains unchanged, it is advantageous when a hardness of the at least one carrier layer is less than that of the product to be cut or ground.

In this case, it can be advantageous when the carrier layer is produced from a material or a material combination, in relation to which the product to be cut or ground has an abrasive effect in such a manner that the at least one carrier layer of the cutting or punching tool that cuts through the product to be cut or ground is sharpened. In the case of said embodiment, the carrier layer is acted upon in an abrasive manner by the product being cut or punched during the cutting or punching operation in such a manner that the bevel always remains unchanged and that the cutting or punching tool according to the invention retains its sharp cutting edge even over a longer period of time.

A preferred further development according to the invention provides that the cutting edge layer of the cutting or punching tool according to the invention is realized as a multilayer cutting edge. To this end, the cutting edge layer is formed from at least two preferably blade-thin material layers.

In order to maintain the desired shaping also on the cutting edge, it is advantageous when the edge is formed from at least two preferably blade-thin material layers of varying hardness.

In this case, a preferred further development according to the invention, which has a particularly sharp cutting edge, provides that one cutting edge layer that forms the cutting edge comprises a hardness that is greater than that of the remaining cutting edge layers that form the edge.

In the case of the cutting or punching tool according to the invention, the edge is formed from at least one blade-thin cutting edge layer. In order to be able to develop the at least one cutting edge layer as blade-thin as possible, it is advantageous when each cutting edge layer has a thickness of between 0.2 and 20μ and preferably between 0.5 and 3μ.

In order to be able to sharpen the cutting or punching tool according to the invention continuously during use and to keep it sharp, it can be advantageous when the cutting or punching tool has at least one tool guide, along which tool guide the cutting or punching tool slides by way of its carrier layer during a cutting operation, that the tool guide is formed of a material that is abrasive to the carrier layer at least on its guide surface, and that the tool guide of the cutting or punching tool that is guided by way of its carrier layer that slides along the tool guide has a sharpening or abrasive effect.

It can be advantageous when the cutting or punching tool has associated therewith at least one sensor, which sensor measures the wear of the cutting or punching tool by way of at least one parameter that alters in dependence on the wear of the tool. A parameter that has altered in dependence on the wear of the tool can be detected by means of such a sensor and consequently the wear on the cutting or punching tool is also able to be automatically measured.

In this case, a preferred embodiment according to the invention provides that the sensor measures the depth of cut or the amount by which the cutting edge of the cutting or punching tool that cuts through the cut or punched product protrudes beyond the surface of the cut product.

In order to balance out a shortening of the edge brought about by wear, it can be advantageous when the cutting or punching tool is held on a tool holder which adjusts the position of the cutting or punching tool relative to the cut product in dependence on the wear of the cutting or punching tool.

The tool according to the invention can be realized as a blade or similar cutting tool, such as is also required, for example, in the home. However, it is also possible for the cutting tool according to the invention to be realized as a rotatably mounted or rotationally driven circular blade.

In this case, a particularly advantageous embodiment according to the invention provides that the circular blade has a truncated-cone-shaped outside contour, the truncated cone base of which forms the cutting edge layer and that the circular blade is mounted so as to be rotatable or rotationally drivable in a coaxial manner with respect to the longitudinal axis of the truncated cone.

In order to obtain the initial incision provided on the carrier layer always such that the cutting or punching tool according to the invention retains its sharp cut edge, it can be advantageous when a grinding element abuts or can abut grindingly against the carrier layer preferably at a spacing from the cut or punched product.

The cutting or punching tool according to the invention can be used in an advantageous manner in the most different realizations for the most varied applications. This, it is also possible for the cutting tool according to the invention to be realized as a saw band and saw blade.

Another advantageous embodiment according to the invention consists in that the cutting tool according to the invention is realized as a splitting band by way of which, for example, leather material or the like is able to be split.

In this case, a preferred embodiment according to the invention provides that the splitting band is realized as a circulating endless belt and/or in that a grinding element abuts or can abut grindingly against the splitting band.

The tool according to the invention is equally usable in an advantageous manner as a punching tool. Thus, the punching tool according to the invention can also be used for punching out the clutch lining sections provided on a clutch disk of an automatic transmission, wherein even over a longer period of use of the punching tool, there would have to be no fears of the clutch lining sections fraying even on their side edge remote from the clutch disk or the clutch disk carrier. In this case, a preferred further development according to the invention provides that the punching tool is intended for pre-punching or punching-out sections from a strip of clutch lining material, and that the punching tool is followed by a punch which presses out a pre-punched or punched-out section from the strip of clutch lining material and preferably presses it against the adhesive face of a clutch disk carrier.

### BRIEF DESCRIPTION OF THE DRAWINGS

Further developments according to the invention are produced from the claims in conjunction with the drawing as well as the description of the figures. The invention is described in more detail below by way preferred exemplary embodiments.

In the drawing:

FIG. 1: shows a cutting or punching tool which can be moved in the longitudinal direction and has a carrier layer which carries the bevel as well as a cutting edge layer which is realized in this case as a multilayer edge, wherein the edge of the punching or cutting tool that is formed from the carrier layer and the cutting edge layer slides during the longitudinal movement along a grinding element which sharpens the bevel on the carrier layer before the punching or cutting tool moves into a cut or punched product that is located beneath the grinding element,

FIG. 2: shows a schematic longitudinal section of a punching or cutting tool which has an edge that is formed from several cutting edge layers as well as a carrier layer that carries the bevel, wherein the oblique bevel on the carrier layer is continued in an equally oblique cutting edge of the edge that is formed from several cutting edge layers,

FIG. 3: shows a cutting or punching tool comparable with FIG. 2, the edge of which has a cutting edge which in this case is trimmed in a roof-shaped manner,

FIG. 4: shows a schematic side view of a cutting or punching tool cutting into a cut product,

FIG. 5: shows a cutting or punching tool which is held on a tool holder which balances out the shortening of the cutting or punching tool brought about by wear, wherein a sensor is provided beneath the cutting or punching tool for detecting the wear on the tool,

FIG. 6: shows a circular blade which is realized with an approximately truncated-cone-shaped outside contour and which cuts into a cut product and when rotating and cutting into the cut product is guided grindingly on a grinding element by way of its carrier layer,

FIG. 7: shows a front view of the circular blade from FIG. 6,

FIG. 8: shows a side view of the circular blade from FIG. 6 and FIG. 7,

FIG. 9: shows the saw blade of a band saw circulating in a band-shaped manner and only shown in a part region in this case,

FIG. 10: shows an equally endlessly circulating splitting band which is provided for splitting leather or similar split or cut products, wherein the splitting band slides grindingly along a grinding element on its longitudinal side that is remote from the split or cut product,

FIG. 11: shows a cross section though cutting plane A-A according to FIG. 10 of the splitting band from FIG. 10, and

FIG. 12: shows a punching device, which has a plurality of punching sleeves arranged in groups, by way of which the clutch lining sections can be pre-punched or punched-out from a strip of clutch lining material, said clutch lining sections then being pressed out onto the adhesive layer that is provided on a clutch disk carrier and there bonded.

### DETAILED DESCRIPTION OF THE PREFERRED EMBODIMENTS

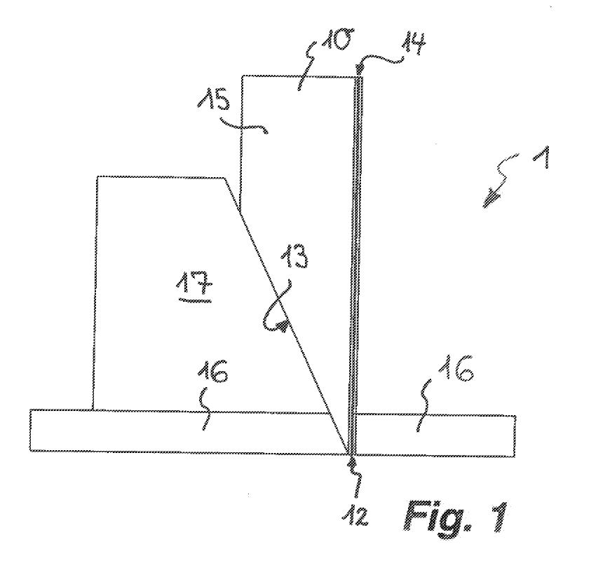

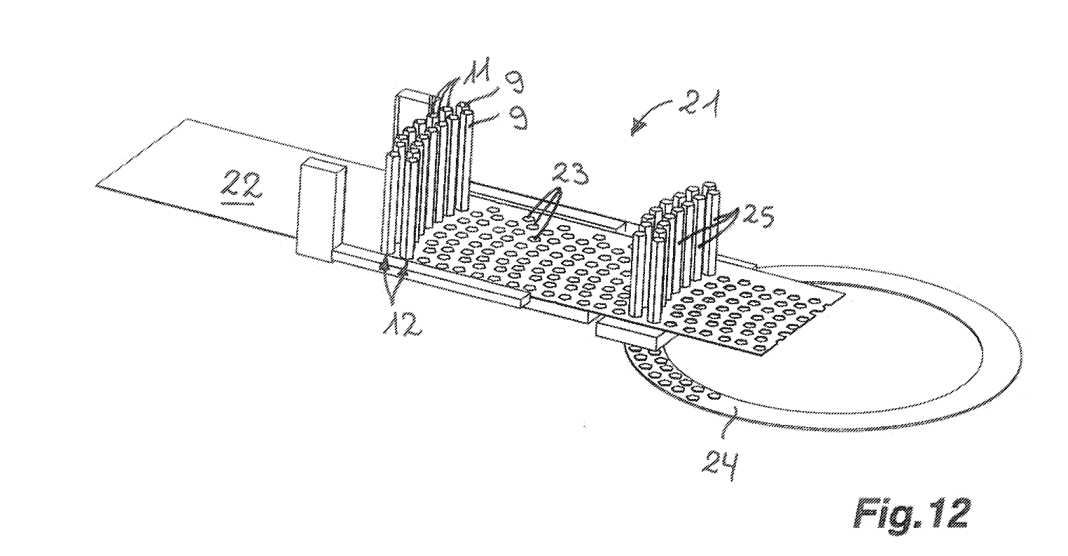

Different realizations 1, 2, 3, 4, 5, 6, 7, 8 and 9 of cutting or punching tools are shown in FIGS. 1 to 12. The cutting or punching tools 1 to 9 shown here are realized in a multilayered manner. Whereas the cutting or punching tools 1 to 8 have a tool blade 10, the punching tool 9 shown in FIG. 12 comprises a tool sleeve 11. The tool blade 10 or the tool sleeve 11 carries an edge which has a cutting edge 12. The tool blade 10 or the tool sleeve 11 tapers in the region of a bevel 13 in the direction toward the cutting edge 12. In this case, the cutting or punching tool 1 to 9 is produced from at least two material layers 14, 15 which are connected together on the flat or peripheral sides and are of varying hardness. The edge is formed from at least one blade-thin and correspondingly sharp-edged cutting edge layer 14 which is connected on at least one of its two flat or peripheral sides to at least one carrier layer 15. This carrier layer 15, which supports the blade-thin cutting edge layer 14 in a dimensionally stable manner, carries the bevel 13 which tapers in the direction toward the cutting edge 12 and comprises a hardness that is less than that of the at least one cutting edge layer 14. Whereas the comparatively soft carrier layer 15 can wear on abrasive material in such a manner that the bevel 13 remains unchanged, the blade-thin cutting edge layer 14 which forms a sharp cutting edge 12 is hard and resistant in such a manner that the cutting or punching tool 1 to 9 does not become blunt even over a longer period of time.

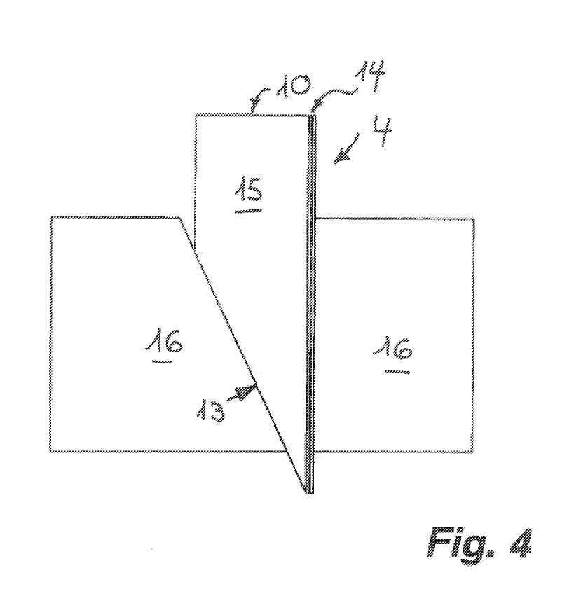

FIGS. 4, 5, 6, 9, 11 and 12 show that the at least one carrier layer 15 comprises a hardness that is less than that of a cut or punched product 16. It can be seen from FIGS. 4, 5, 9 and 12 that the carrier layer 15 can be produced from one material or a material combination, in relation to which the cut or punched product 16 has an abrasive effect in such a manner that the at least one carrier layer 15 of the cutting or punching tool 4, 5, 7 and 9 that cuts through the cut or punched product is sharpened. As the carrier layer 15 is stressed in a grinding manner by the abrasive cut or punched product 16 during the cutting or punching operation in such a manner that the bevel 13 provided on the carrier layer 15 remains unchanged, a sharp cutting edge 12 is also always provided by the cutting edge layer 14.

In contrast, FIGS. 1, 6 to 8 as well as 10 and 11 show that the cutting or punching tools 1, 6 and 8 can also have associated therewith a tool guide, along which tool guide the cutting or punching tool 1, 6 and 9 slides by way of its carrier layer 15 during a cutting operation, the tool guide is formed of a material that is abrasive to the carrier layer 15 at least on its guide surface. The tool guide, which is formed in this case by a grinding element 17, has a sharpening or abrasive effect on the cutting or punching tool 1, 6 and 9 which is guided by way of its carrier layer 15 sliding along the grinding element 17.

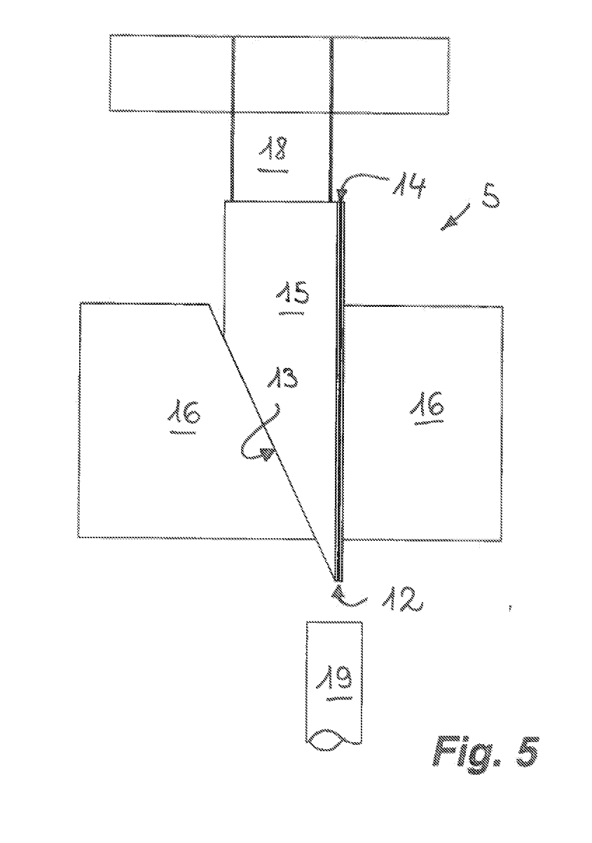

In this case, it is indicated in FIG. 5 that the cutting or punching tool 5 can be held on a tool holder 18 which adjusts the position of the cutting or punching tool 5 relative to the cut or punched product 16 in dependence on the wear of the cutting or punching tool 5. In order to detect the wear on the tool and in order to be able to adjust the tool holder 18 in dependence on the wear on the tool, a sensor 19 is provided which measures the wear on the cutting or punching tool 5 by way of at least one parameter that alters in dependence on the wear on the tool. Said parameter can measure the depth of cut or—as in FIG. 5—the amount the cutting edge 12 of the cutting or punching tool cutting through the cut or punched product 16 projects beyond the surface of the cut product or the surface of the punched product.

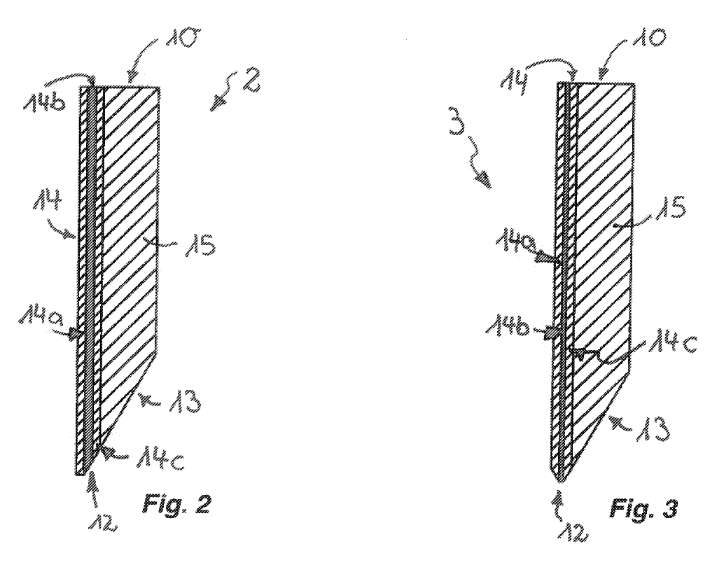

So that the edge also always has a sharp cutting edge 12, the realization shown in more detail in FIGS. 2 and 3, where the edge is formed from at least two preferably blade-thin material layers 14a, 14b and 14c, is preferred. In this case, the material layers 14a, 14b and 14c of the edges shown in FIGS. 2 and 3 comprise blade-thin material layers of varying hardness. As in this case the cutting edge layers 14a, 14b and 14c have varying hardnesses, the tool blade 10 of said punching or cutting tools 2, 3 is characterized by a long permanent sharpness. As, in this case, the cutting edge layer 14b that forms the tip of the cutting edge 12 has a hardness that is greater than that of the remaining cutting edge layers 14a and 14c that form the edge, a very thin and correspondingly sharp edge is formed. The cutting edge layers 14a and 14c arranged on both sides of the central cutting edge layer 14b support the cutting edge layer 14b that forms the tip of the cutting edge 12. The tool blade 10 of the cutting or punching tools 2, 3 shown in FIGS. 2 and 3 is characterized by a high level of basic sharpness as the cutting edge layers 14a, 14b and 14c are together still very thin and form a thin cutting edge layer 14 in spite of the multiple layers. The cutting edge layers 14a, 14b and 14c, which are of the same thickness or can also be developed with varying thicknesses, can comprise a hardness, for example, of between 3,000 and 6,000 HV and in particular of between 3,800 and 5,000 HV. Thus, for example, the cutting edge layer 14a can comprise a hardness of 4,000 HV and the cutting edge layer 14c which is arranged on the opposite side of the tool blade 10 can comprise a hardness of 3,800 HV, whilst, in contrast, the cutting edge layer 14b that carries the tip of the cutting edge 12 has a hardness of, for example, 5,000 HV. The number or required cutting edge layers can be established in dependence on the application provided. It is clear from a comparison between FIGS. 2 and 3 that the clearance angle of the cutting edge layers 14a, 14b, 14c forming the cutting edge can be developed differently depending on the cut product and on the application. Whereas the bevel 13 on the carrier layer 15 in the case of the cutting or punching tool 2 shown in FIG. 2 is continued in an equally oblique cutting edge 12, the cutting edge 12 of the cutting or punching tool 3 shown in FIG. 3 is realized in a roof-shaped manner with oblique faces tapering to a cutting point.

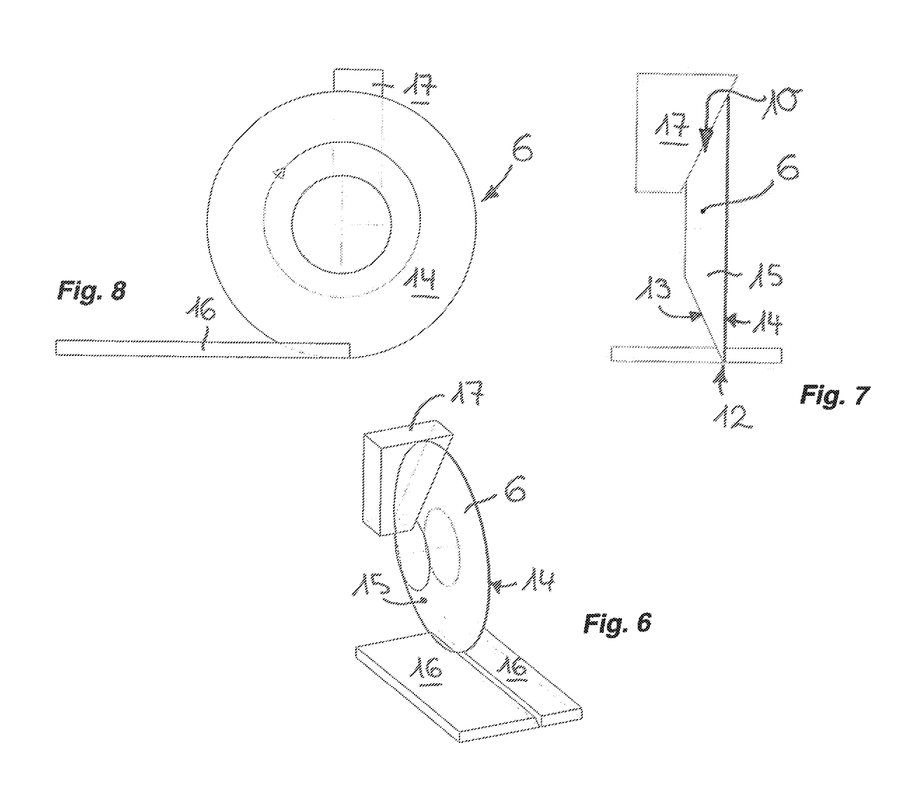

FIGS. 6 to 8 show that the cutting tool 6 can also be realized as a rotatably mounted or rotationally driven circular blade. The circular blade 6 shown in FIGS. 6 to 8 has a truncated-cone-shaped outside contour, the truncated cone base of which forms the at least one cutting edge layer 14. In this case, the circular blade 6 is mounted so as to be rotatable or rotationally drivable in a coaxial manner with respect to the longitudinal axis of the truncated cone. A grinding element 17 abuts against the carrier layer 15 of the circular blade 6 at a spacing from the cut product 16 in such a manner that the cutting element is guided in an abrasive or sharpening manner on the carrier layer 15 of the circular blade 6.

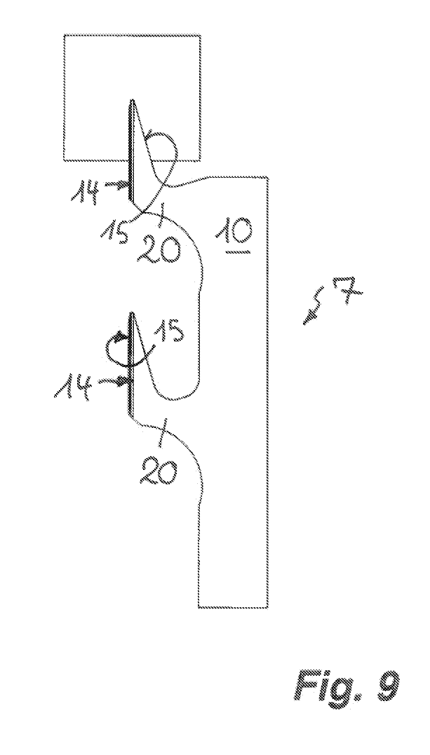

It is clear from FIG. 9 that the cutting tool 7 can also be realized as a saw blade of a saw. Saw teeth 20, which carry an edge with a cutting edge 12, protrude from the saw blade that serves as a tool blade 10. In this case, the saw teeth 20 carrying the edge are formed from at least two material layers 14, 15 that are connected together on the flat sides. Whereas the carrier layer 15 is produced from a material that is softer than that of the cut product, the at least one cutting edge layer 14, and here the cutting edge layers 14a, 14b and 14c that form the edge, comprise a hardness that is greater than that of the product to be cut. The tool blade 10, which is realized here as a saw blade, can also be realized as a saw band of a band saw that circulates in a band-shaped manner.

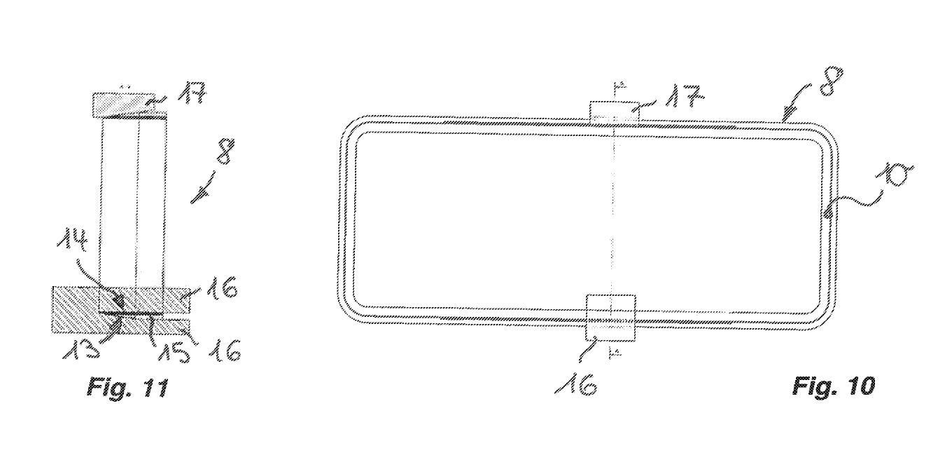

FIGS. 10 and 11 show a cutting tool 8 which is realized in this case as a splitting band, by way of which splitting band a material layer 16 and in particular a leather layer can be split into at least two layers. The cutting tool 8 realized as a splitting band is in this case realized in a splitting device as a splitting band that is guided circulating along a rectangular path. Whereas the splitting band, on its one longitudinal side of the splitting band, splits the cut product, on its opposite longitudinal side of the splitting band the splitting band is guided on a grinding element 17 which has an abrasive effect on the carrier layer 15 of the splitting band in such a manner that the bevel on the carrier layer 15 is always ensured and the splitting band perpetually has a sharp cutting edge.

FIG. 12 shows a schematic perspective representation of a punching machine 21. Several punching tools 9, which are arranged in a punching tool group at a small spacing apart from one another, are provided in the punching machine 21. The punching tools 9 which are guided so as to be displaceable in their longitudinal direction and are realized as tool sleeves are intended for the purpose of punching out, or at least pre-punching, individual clutch lining sections 23 from a strip of clutch lining material 22. Once the clutch lining sections 23 have been punched out or pre-punched, the strip of clutch lining material 22 is advanced further until a clutch disk or a clutch disk carrier 24 is situated beneath said strip of clutch lining material 22. Said clutch lining carrier 24, which is realized in this case in a ring-shaped manner, comprises an adhesive layer on its flat side that faces the strip of clutch lining material 22. As soon as the strip of clutch lining material 22 is situated above the clutch disk carrier 24, the clutch lining sections 23 that are still located in the strip of clutch lining material 22 are pressed out of the strip of material by means of pressure punches and are pressed onto the adhesive layer of the clutch disk carrier 24, where they are then permanently fixed. As the punching tools 9 always have a sharp cutting edge 12, performance-reducing fraying on both sides of the punched-out clutch lining sections 23 are not to be feared.

The punching tools 9 provided in the punching machine 21 according to FIG. 12 in each case form a tool sleeve, said tool sleeves being constructed according to the exemplary embodiments 1 to 8 shown in FIGS. 1 to 11. The sleeve-shaped punching tools 9 also comprise a cutting edge on the end face of their sleeve shape that faces the punched product. In this case, the tool sleeve of the punching tools 9 tapers in the direction toward the cutting edge 12 in the region of a bevel that is arranged in this case on the inside or outside. The stamping tools 9 are also produced from at least two material layers that are connected together on the flat sides, the edge being formed from at least one blade-thin cutting edge layer which is arranged on the outside or inside periphery of the sleeve-shaped cutting tool. This at least one cutting edge layer is connected on at least one of its two peripheral sides to at least one carrier layer which carries the bevel that tapers in the direction toward the cutting edge 12. In this case, the carrier layer comprises a hardness that is less than that of the at least one cutting edge layer. As also in the cases of exemplary embodiments 1 to 8 according to FIGS. 1 to 11, in the case of the punching tool 9 according to FIG. 12 a realization where the edge is formed by at least two and preferably by three cutting edge layers preferably of varying hardness is also preferred.

1. A cutting or punching tool (1, 2, 3, 4, 5, 6, 7, 8, 9) comprised of at least two material layers (14, 15) and including a tool blade (10) or a tool sleeve (11) that tapers in a direction toward a cutting edge (12) in a region of a bevel (13), the at least two material layers (14, 15) are connected together on flat sides thereof and are produced from materials of varying hardness, the cutting edge is formed from at least one blade-thin cutting edge layer (14; 14a, 14b, 14c) of the at least two material layers, the at least one cutting edge layer (14; 14a, 14b, 14c) is connected at least on one of its two flat or peripheral sides to at least one carrier layer (15) of the at least two material layers, said at least one carrier layer (15) carries the bevel (13) that tapers in the direction of the cutting edge (12) and the at least one carrier layer (15) has a hardness that is less than that of the at least one cutting edge layer (14; 14a, 14b, 14c).

2. The cutting or punching tool as claimed in claim 1, wherein the at least one cutting edge layer (14; 14a, 14b, 14c) has a hardness that is greater than that of a product to be cut or punched.

3. The cutting or punching tool as claimed in claim 1, wherein the at least one carrier layer (15) has a hardness that is less than that of a product to be cut or punched.

4. The cutting or punching tool as claimed in claim 1, wherein the cut or punched product has an abrasive effect on the at least one carrier layer (15) such that the at least one carrier layer (15) of the cutting or punching tool that cuts through the cut or punched product (16, 22) is sharpened.

5. The cutting or punching tool as claimed in claim 1, wherein the cutting edge is formed from at least two of the blade-thin material layers (14a, 14b, 14c).

6. The cutting or punching tool as claimed in claim 1, wherein the cutting edge is formed from at least two of the blade-thin material layers (14a, 14b, 14c) of varying hardness.

7. The cutting or punching tool as claimed in claim 6, wherein a one said cutting edge layer (14b) that forms the cutting edge (12) comprises a hardness that is greater than that of the remaining cutting edge layers (14a, 14c) that form the cutting edge.

8. The cutting or punching tool as claimed in claim 6, wherein each of the cutting edge layers has a thickness of between 0.2 and 20μ.

9. The cutting or punching tool as claimed in claim 1, further comprising at least one tool guide, the cutting or punching tool slides along said tool guide by way of the at least one carrier layer (15) during a cutting operation, the tool guide is formed of a material that is abrasive to the carrier layer (15) at least on its guide surface and the tool guide has a sharpening or abrasive effect for the cutting or punching tool that is guided by way of the at least one carrier layer (15) sliding along the tool guide.

10. The cutting or punching tool as claimed in claim 1, wherein the cutting or punching tool has associated therewith at least one sensor (19), said sensor (19) measures wear of the cutting or punching tool (5) by way of at least one parameter that alters in dependence on the wear on the tool.

11. The cutting or punching tool as claimed in claim 10, wherein the sensor (19) measures a depth of cut or an amount by which the cutting edge (12) of the cutting or punching tool (5) that cuts through the cut or punched product (16) protrudes beyond a surface of the cut or punched product.

12. The cutting or punching tool as claimed in claim 10, wherein the cutting or punching tool (5) is held on a tool holder (18) which adjusts a position of the cutting or punching tool (5) relative to the cut or punched product (16) in dependence on the wear of the cutting or punching tool (5).

13. The cutting or punching tool as claimed in claim 1, wherein the cutting tool (6) is formed as a rotatably mounted or rotationally driven circular blade.

14. The cutting or punching tool as claimed in claim 13, wherein the circular blade (6) has a truncated-cone-shaped outside contour, the truncated cone base of which is formed as the at least one cutting edge layer (14; 14a, 14b, 14c) and the circular blade is mounted so as to be rotatable or rotationally drivable in a coaxial manner with respect to a longitudinal axis of the truncated cone.

15. The cutting or punching tool as claimed in claim 1, wherein a grinding element (17) abuts grindingly against the carrier layer (15) at a spacing from the cut or punched product (16).

16. The cutting or punching tool as claimed in claim 1, wherein the cutting tool (7) is formed as a saw band or saw blade.

17. The cutting or punching tool as claimed in claim 1, wherein the cutting tool (8) is formed as a splitting band.

18. The cutting or punching tool as claimed in claim 17, wherein the splitting band (8) is formed as a circulating endless band and a grinding element (17) abuts grindingly against the splitting band.

19. The cutting or punching tool as claimed in claim 1, wherein the punching tool (9) is a clutch lining material punch for pre-punching or punching-out sections (23) from a strip of clutch lining material (22), and the punching tool (9) is followed by a punch (25) which presses out a pre-punched or punched-out section (23) from the strip of clutch lining material (22) and presses it against an adhesive face of a clutch disk carrier (24).
